(19) United States
(12) Patent Application Publication
(10) Pub. No.: US 2010/0137022 A1
(43) Pub. Date: Jun. 3, 2010

(54) MOBILE COMMUNICATION APPARATUS AND OPERATING METHOD THEREOF

(75) Inventors: Sheng-Hong YANG, NANJING (CN); Gui-Qing WAN, NANJING (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/325,146

(22) Filed: Nov. 29, 2008

(51) Int. Cl. H04M 1/00

(52) U.S. Cl. 455/552.1; 340/689; 455/556.1

(57) ABSTRACT

The invention discloses a mobile communication apparatus. The mobile communication apparatus includes a sensing module, a determining module, and a switching module. The sensing module senses a rotational parameter of the mobile communication apparatus. The determining module is electrically connected to the sensing module for determining whether the rotational parameter reaches a threshold. The switching module is electrically connected to the determining module for switching the mobile communication apparatus to a first communication mode or maintaining the mobile communication apparatus in the first communication mode when determining that the rotational parameter reaches the threshold.

### BACKGROUND

1. Field of Invention

The present invention relates to a mobile communication apparatus, and more particularly, to a mobile communication apparatus for switching the mobile communication mode automatically and the method thereof.

2. Description of Related Art

In recent years, as mobile communication technology progresses, the standard of mobile communication network becomes more diverse. Hence, many telecommunication entrepreneurs have been able to simultaneously provide services for the second generation (2G) mobile communication networks and the third generation mobile (3G) communication networks. Dual mode or multi-mode handsets are also becoming increasingly available for the 2G and 3G mobile communication network.

However, due to the functions of different network models, the operation interface of conventional dual mode or multi-mode handsets is usually too complicated and inconvenient for users. In addition, if the user wants to switch the mobile communication mode or switch the function in one mobile communication mode to another, the user needs to press the button many times or touch the screen to make it work. On the other hand, it is also difficult for the present dual mode or multi-mode handsets to conceal private data or functions simply.

Therefore, the present invention provides a mobile communication apparatus and a method thereof to solve the problem as mentioned above.

### SUMMARY

The invention provides a mobile communication apparatus. The mobile communication apparatus includes a sensing modules a determining modules and a switching module. The sensing module senses the rotational parameter of the mobile communication apparatus. The determining module is electrically connected to the sensing module and determines whether the rotational parameter reaches a threshold. The switching module is electrically connected to the determining module. The switching module switches the mobile communication apparatus to a first communication mode or maintains the mobile communication apparatus in the first communication mode when determining that the rotational parameter reaches the threshold.

Comparing with the prior art the user just needs to rotate the mobile communication apparatus, and then the communication modes or the functions of the mobile communication apparatus can be switched automatically according to the mobile communication apparatus and the operation method of the present invention. Furthermore, the private data or functions can also be concealed easily by just rotating the mobile communication apparatus.

These and other features, aspects, and advantages of the present invention will become better understood with reference to the following description and appended claims.

### BRIEF DESCRIPTION OF THE DRAWINGS

The invention can be more fully understood by reading the following detailed description of the embodiment, with reference made to the accompanying drawings as follows:

FIG. 1 shows a block diagram of a mobile communication apparatus according to the first embodiment of the present invention;

FIG. 2 shows an example of switching the caller by rotating the mobile phone.

FIG. 3 shows an example of switching the communication network by rotating the mobile phone.

FIG. 4 shows an example of switching the security mode by rotating the mobile phone.

FIG. 5 shows a flowchart of a method for a mobile communication apparatus according to the fourth embodiment of the present invention.

FIG. 6 shows a flowchart of a method for a mobile communication apparatus according to the fifth embodiment of the present invention.

FIG. 7 shows a flowchart of a method for a mobile communication apparatus according to the sixth embodiment of the present invention.

### DETAILED DESCRIPTION

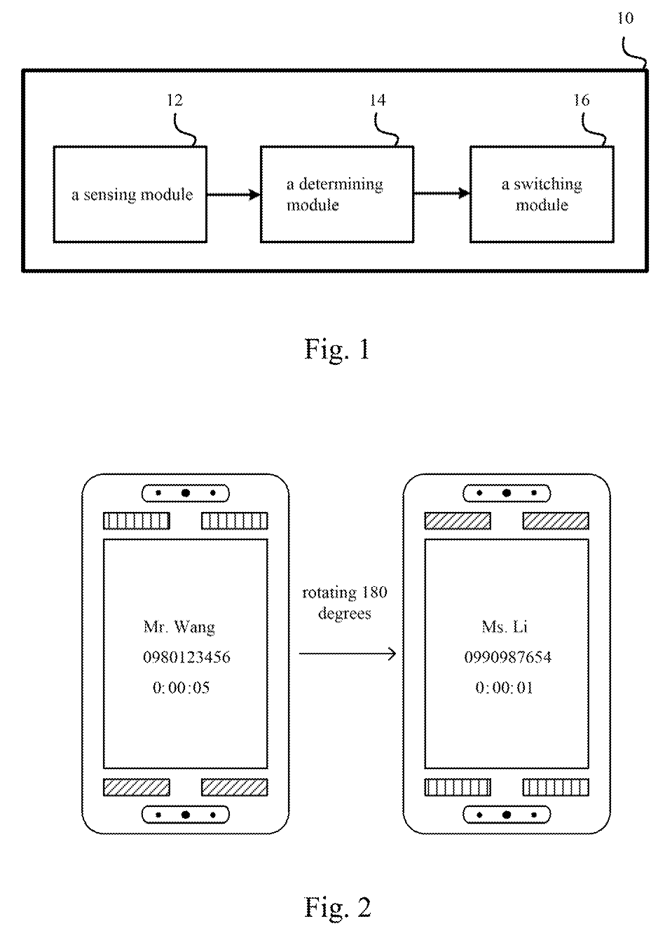

FIG. 1 shows a block diagram of a mobile communication apparatus according to the first embodiment of the present invention. The mobile communication apparatus 10 includes a sensing module 12, a determining module 14 and a switching module 16. The sensing module 12 senses the rotational parameter of the mobile communication apparatus 10. The determining module 14 is electrically connected to the sensing module 12 and determines whether the rotational parameter reaches a threshold. The switching module 16 is electrically connected to the determining module 14. The switching module 16 switches the mobile communication apparatus 10 to a first communication mode or maintains the mobile communication apparatus 10 in the first communication mode when determining that the rotational parameter reaches the threshold.

On the other hand, the switching module 16 switches the mobile communication apparatus 10 to a second communication mode or maintains the mobile communication apparatus 10 in the second communication mode when determining that the rotational parameter does not reach the threshold.

In practical applications, the sensing module 12 comprises a gyroscope or a three-axis accelerometer. The rotational parameter is in terms of an angular velocity or a rotational angle relative to a reference angle. The first communication mode is for communication with a first caller, and the second communication mode is for communication with a second caller.

For example, while the user is engaged in a call with a first friend, Mr. Wang, and notified of another incoming call from a second friend, Ms. Li, by the service of call waiting, the user can rotate the mobile phone with an angle so that the sensing module 12 senses a rotational parameter, which is in terms of an angular velocity or a rotational angle, and then the determining module 14 determines whether the rotational parameter reaches a threshold. As shown in FIG. 2, if the user rotates the mobile phone almost 180 degrees, the determining module 14 switches the caller from Mr. Wang to Ms. Li immediately.

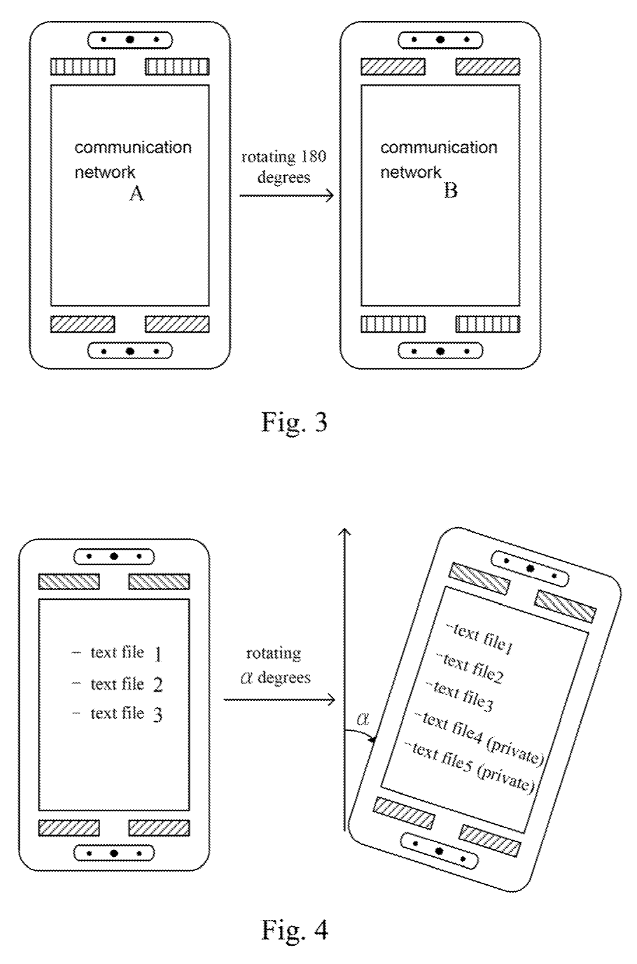

In addition, if the mobile communication apparatus 10 is used for a plurality of communication networks, the first and second communication mode mentioned above may be according to a first and second communication network respectively. For example, if a dual mode mobile phone is used for the communication network A and the communication network B, the user can switch the communication mode from the communication network A to the communication network B just by almost about 180 degrees of clockwise rotation, as shown in FIG. 3.

On the other hand, the mobile communication apparatus 10 can also be used for the multi-communication mode. For example, if a multi-mode mobile phone is used for the communication network C, the communication network D and the communication network E, the user can switch the communication mode from the communication network C to the communication network D or the communication network E orderly by rotating the mobile clockwise. Furthermore, the user can switch the communication mode into the communication network C, the communication network D, or the communication network E arbitrarily by different rotations, such as clockwise rotation or counter-clockwise rotation.

FIG. 1 also represents a block diagram of a mobile communication apparatus according to the second embodiment of the present invention. The mobile communication apparatus 10 includes a sensing module 12, a determining module 14 and a switching module 16. The biggest difference between the first and second embodiment of the present invention is that the switching module 16 can make the mobile communication apparatus 10 activate or show a first application when determining that the rotational parameter reaches the threshold.

Furthermore, the switching module 16 can make the mobile communication apparatus 10 activate or show a second application when determining that the rotational parameter does not reach the threshold.

For example, while the user is surfing the Internet on the mobile phone, and notified of an incoming phone call, the user can switch the mobile phone into the communication program to answer the incoming phone call by rotating the mobile with a certain angle. That is to say, the user can answer the incoming phone call without touching the screen or pressing the button.

FIG. 1 also represents a block diagram of a mobile communication apparatus according to the third embodiment of the present invention. The biggest difference between the first and the third embodiment of the present invention is that the switching module 16 can turn off a security mode of the mobile communication apparatus 10 when determining that the rotational parameter reaches the threshold.

Furthermore, the switching module 16 can turn on the security mode of the mobile communication apparatus 10 when determining that the rotational parameter does not reach the threshold.

For example, while using the notepad function of the mobile phone, assuming that there are five text files and two of them are with personal information, the user can keep these two private text files in a security mode on the condition of rotating with a little angle or not rotating the mobile phone. The user can check through the private text file by rotating the mobile phone α degrees as shown in FIG. 4.

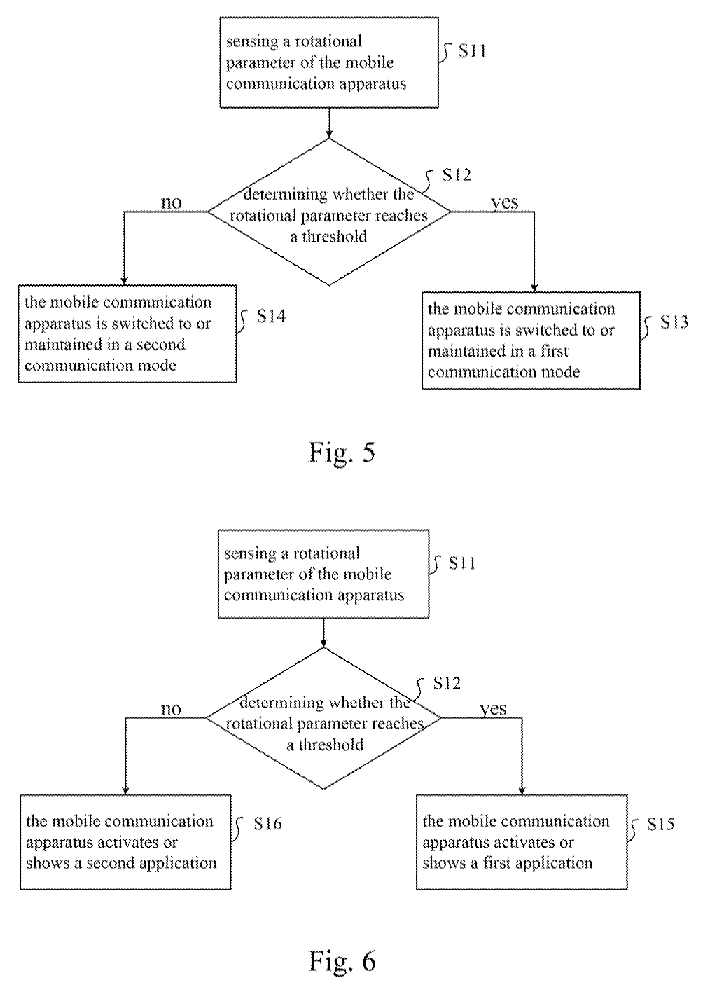

FIG. 5 shows a flowchart of a method for a mobile communication apparatus according to the fourth embodiment of the present invention. As shown in FIG. 5, the step S11 is taken at first to sense a rotational parameter of the mobile communication apparatus, and then the method continues to step S12 of determining whether the rotational parameter reaches a threshold. The step S13 is taken so that the mobile communication apparatus is switched to or maintained in a first communication mode when determining that the rotational parameter reaches the threshold.

On the contrary, the step S14 is taken so that the mobile communication apparatus is switched to or maintained in a second communication mode when determining that the rotational parameter does not reach the threshold.

In practical applications, the first communication mode is for communication with a first caller, and the second communication mode is for communication with a second caller. The rotational parameter is in terms of an angular velocity or a rotational angle relative to a reference angle.

If the mobile communication apparatus is used for multi-communication modes, the first communication mode may be according to a first communication network, and the second communication mode may be according to a second communication network.

FIG. 6 shows a flowchart of a method for a mobile communication apparatus according to the fifth embodiment of the present invention. As shown in FIG. 6, the step S11 is taken at first to sense a rotational parameter of the mobile communication apparatus, and then the method continues to step S12 of determining whether the rotational parameter reaches a threshold. The step S15 is taken so that the mobile communication apparatus activates or shows a first application when determining that the rotational parameter reaches the threshold.

On the contrary, the step S16 is taken so that the mobile communication apparatus activates or shows a second application when determining that the rotational parameter does not reach the threshold. That is, the user can switch the mobile to the first application or the second application arbitrarily by rotating the mobile.

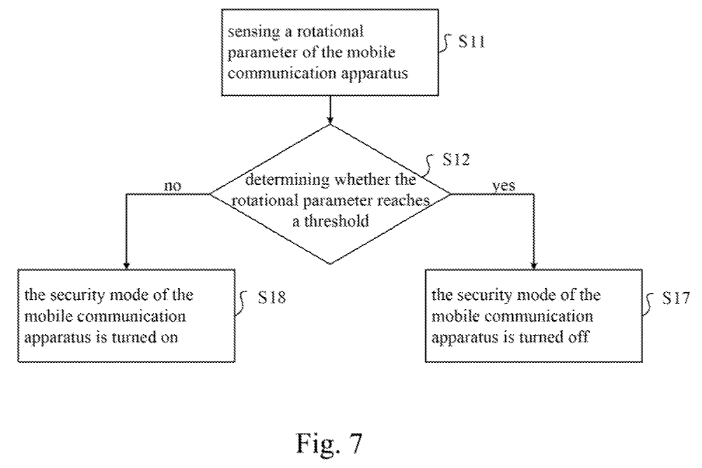

FIG. 7 shows a flowchart of a method for a mobile communication apparatus according to the sixth embodiment of the present invention. As shown in FIG. 7, the step S11 is taken at first to sense the rotational parameter of the mobile communication apparatus, and then the method continues to step S12 to determine whether the rotational parameter reaches a threshold. The step S17 is taken so that the security mode of the mobile communication apparatus is turned off when determining that the rotational parameter reaches the threshold.

On the contrary, the step S18 is taken so that the security mode of the mobile communication apparatus is turned on when determining that the rotational parameter does not reach the threshold. That is, when the mobile is rotated to a certain angle, the concealed files or functions are showed on the mobile phone.

Comparing with the prior arts the user just needs to rotate the mobile communication apparatus, and then the communication modes or the functions of the mobile communication apparatus can be switched automatically according to the mobile communication apparatus and the operation method of the present invention. Furthermore, the private data or functions can also be concealed easily by just rotating the mobile communication apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile communication apparatus comprising:
a sensing module for sensing a rotational parameter of the mobile communication apparatus;
a determining module electrically connected to the sensing module for determining whether the rotational parameter reaches a threshold; and
a switching module electrically connected to the determining module for switching the mobile communication apparatus to a first communication mode or maintaining the mobile communication apparatus in the first communication mode when determining that the rotational parameter reaches the threshold.

2. The mobile communication apparatus as claimed in claim 1, wherein the switching module switches the mobile communication apparatus to a second communication mode or maintains the mobile communication apparatus in the second communication mode when determining that the rotational parameter does not reach the threshold.

3. The mobile communication apparatus as claimed in claim 2, wherein the first communication mode is for communication with a first caller, and the second communication mode is for communication with a second caller.

4. The mobile communication apparatus as claimed in claim 2, wherein the mobile communication apparatus is used in a plurality of communication networks, and the first communication mode is according to a first communication network, and the second communication mode is according to a second communication network.

5. The mobile communication apparatus as claimed in claim 1, wherein the sensing module comprises a gyroscope or a three-axis accelerometer.

6. The mobile communication apparatus as claimed in claim 1, wherein the rotational parameter is in terms of an angular velocity or a rotational angle relative to a reference angle.

7. A mobile communication apparatus comprising:
a sensing module for sensing a rotational parameter of the mobile communication apparatus;
a determining module electrically connected to the sensing module for determining whether the rotational parameter reaches a threshold; and
a switching module electrically connected to the determining module for making the mobile communication apparatus activate or show a first application when determining that the rotational parameter reaches the threshold.

8. The mobile communication apparatus as claimed in claim 7, wherein the switching module makes the mobile communication apparatus activate or show a second application when determining that the rotational parameter does not reach the threshold.

9. The mobile communication apparatus as claimed in claim 7, wherein the sensing module comprises a gyroscope or a three-axis accelerometer.

10. The mobile communication apparatus as claimed in claim 7, wherein the rotational parameter is in terms of an angular velocity, or a rotational angle relative to a reference angle.

11. A mobile communication apparatus, comprising:
a sensing module for sensing a rotational parameter of the mobile communication apparatus;
a determining module electrically connected to the sensing module for determining whether the rotational parameter reaches a threshold; and
a switching module electrically connected to the determining module for turning off a security mode of the mobile communication apparatus when determining that the rotational parameter reaches the threshold.

12. The mobile communication apparatus as claimed in claim 11, wherein the switching module turns on the security mode of the mobile communication apparatus when determining that the rotational parameter does not reach the threshold.

13. The mobile communication apparatus as claimed in claim 11, wherein the sensing module comprises a gyroscope or a three-axis accelerometer.

14. The mobile communication apparatus as claimed in claim 11, wherein the rotational parameter is in terms of an angular velocity, or a rotational angle relative to a reference angle.

15. A method of operating a mobile communication apparatus, the method comprising:
(a) sensing a rotational parameter of the mobile communication apparatus;
(b) determining whether the rotational parameter reaches a threshold, and
(c) switching the mobile communication apparatus to a first communication mode or maintaining the mobile communication apparatus in the first communication mode when determining that the rotational parameter reaches the threshold.

16. The method as claimed in claim 15, further comprising:
(d) switching the mobile communication apparatus to a second communication mode or maintaining the mobile communication apparatus in the second communication mode when determining that the rotational parameter does not reach the threshold.

17. The method as claimed in claim 16, wherein the first communication mode is for communication with a first caller, and the second communication mode is for communication with a second caller.

18. The method as claimed in claim 16, wherein the mobile communication apparatus is used in a plurality of communication networks, and the first communication mode is according to a first communication network, and the second communication mode is according to a second communication network.

19. The method as claimed in claim 15, wherein the rotational parameter is in terms of an angular velocity, or a rotational angle relative to a reference angle.

20. A method of operating a mobile communication apparatus, the method comprising:
(a′) sensing a rotational parameter of the mobile communication apparatus;
(b′) determining whether the rotational parameter reaches a threshold; and
(c′) making the mobile communication apparatus activate or show a first application when determining that the rotational parameter reaches the threshold.

21. The method as claimed in claim 20, further comprising:
(d′) making the mobile communication apparatus activate or show a second application when determining that the rotational parameter does not reach the threshold.

22. The method as claimed in claim 20, wherein the rotational parameter is in terms of an angular velocity or a rotational angle relative to a reference angle.

23. A method of operating a mobile communication apparatus, comprising:
(a″) sensing a rotational parameter of the mobile communication apparatus;
(b″) determining whether the rotational parameter reaches a threshold; and
(c″) turning off a security mode of the mobile communication apparatus when determining that the rotational parameter reaches the threshold.

24. The method as claimed in claim 23, further comprising:
(d″) turning on the security mode of the mobile communication apparatus when determining that the rotational parameter does not reach the threshold.

25. The method as claimed in claim 23, wherein the rotational parameter is in terms of an angular velocity, or a rotational angle relative to a reference angle.
